(19) United States
(12) Patent Application Publication
(10) Pub. No.: US 2008/0024444 A1
(43) Pub. Date: Jan. 31, 2008

(54) Display scrolling method, display scrolling device, and display scrolling program

(75) Inventors: Yuichi Abe, Tokyo (JP); Yoichiro Sako, Tokyo (JP); Itaru Kawakami, Kanagawa (JP); Mitsuru Takehara, Tokyo (JP); Takatoshi Nakamura, Ibaraki (JP)

Correspondence Address: WOLF GREENFIELD & SACKS, P.C., 600 ATLANTIC AVENUE, BOSTON, MA, 02210-2206, US

(73) Assignee: Sony Corporation, Tokyo (JP)

(21) Appl. No.: 11/827,277

(22) Filed: Jul. 11, 2007

(30) Foreign Application Priority Data
Jul. 29, 2006 (JP) JP2006-207257

(51) Int. Cl. G06F 3/033

(52) U.S. Cl. 345/157

(57) ABSTRACT

A display scrolling method for scrolling content displayed on a display screen of a display device according to a user operation includes the steps of, when a pointer of a pointing device is started to be dragged, calculating an amount of scrolling of the content to be scrolled with respect to a unit amount of movement of the pointer on the basis of a distance between the position of the pointer and a predetermined reference point; and displaying the content by scrolling the content displayed on the display screen by the determined amount of scrolling in a direction associated with a moving direction of the pointer.

### CROSS REFERENCES TO RELATED APPLICATIONS

The present invention contains subject matter related to Japanese Patent Application JP 2006-207257 filed in the Japanese Patent Office on Jul. 29, 2006, the entire contents of which are incorporated herein by reference.

### BACKGROUND OF THE INVENTION

1. Field of the Invention

The present invention relates to a display scrolling method, a display scrolling device, and a display scrolling program for scrolling display content.

2. Description of the Related Art

With the digitization of information, there have been increasing opportunities of handling a large amount of information. In information processing apparatuses such as personal computers, a window system is generally used as a method for displaying various types of information.

In the window system, even if the display size of the content to be displayed on a screen of a display device is larger than a display area (display window) of the display device, the content can be displayed as desired by scrolling the displayed content. To implement such scroll display, for example, the following techniques are used:

(A) a scroll bar technique;

(B) a drag-scroll technique; and

(C) a keep-scroll technique.

With those techniques, for example, as shown in FIG. 13, on a display area (or display window) 50, a portion of display content 60 is displayed in a manner in which the display content 60 can be viewed through a “window”. The display content 60 may include a still image such as a map or a photograph, a motion picture, a document, a spreadsheet, and an address book. The display content 60 may also include an image formed of thumbnail images (hereinafter referred to simply as “thumbnails”) of the content.

In the scroll bar technique in (A) above, as shown in FIG. 13, a vertical scroll bar 51 is displayed on the right side of the display area 50, and vertical scroll buttons 51A and 51B are displayed on the upper and lower ends of the vertical scroll bar 51, respectively. A horizontal scroll bar 52 is displayed on the lower side of the display area 50, and horizontal scroll buttons 52A and 52B are displayed on the left and right ends of the horizontal scroll bar 52, respectively.

When a slider in the vertical scroll bar 51 is moved up or down using a mouse (not shown) or the like, the display content 60 is scrolled so that the position of the display content 60 on the display area 50 is moved down or up. When a slider in the horizontal scroll bar 52 is moved to the right or left, the display content 60 is scrolled so that the position of the display content 60 on the display area 50 is moved to the left or right. When the vertical scroll button 51A or 51B is pressed, or when the horizontal scroll button 52A or 52B is pressed, the display content 10 is scrolled down or up, or right or left by a unit amount each time it is pressed.

Therefore, the scroll bar technique in (A) above allows continuous scrolling display of the display content 60. Further, by clicking the scroll button 51A, 51B, 52A, or 52B, the display content 60 can be slightly and discontinuously scrolled a predetermined amount and displayed.

In the drag-scroll technique in (B) above, for example, as shown in FIG. 14A, a mouse pointer 53 is placed at a desired point PA in the display area 50. As shown in FIG. 14B, the mouse pointer 53 is dragged to a point PB, thereby scrolling the display content 60 from a position indicated by a broken line to a position indicated by a solid line according to the direction and distance from the point PA to the point PB.

Since the amount of drag movement corresponds to the amount of scrolling, it is easy to understand the amount by which to drag the mouse pointer 53, and a delicate operation can be performed. Such a single simple series of operations of “grabbing” and “moving” display content is intuitive and easy to learn. Further, it is easy to scroll diagonally.

In the keep-scroll technique in (C) above, as shown in FIG. 15A, a desired point PA in the display area 50 is clicked and, as shown in FIG. 15B, the mouse pointer 53 is moved to a point PB, thereby scrolling the display content 60 in the direction toward the point PB as viewed from the point PA at a speed corresponding to the distance between the points PA and PB. If a mouse button is kept pressed when the mouse pointer 53 is located at the position PB, the display content 60 is continuously scrolled. When the mouse button is released, the scroll stops.

Since the distance between the position PA obtained when the mouse button was pressed and the current position PB corresponds to the scroll speed, it is possible to scroll quickly across a wide range. Further, the display content 60 can be continuously scrolled merely by maintaining the distance between the position PA obtained when the mouse button was pressed and the current position PB.

Scrolling methods of the related art are disclosed in Japanese Unexamined Patent Application Publication Nos. 02-037394 and 07-168552.

### SUMMARY OF THE INVENTION

However, the scroll bar technique in (A) above has a usability problem. That is, basically, the scroll bars 51 and 52 are used to implement a continuous scroll, and the scroll buttons 51A, 51B, 52A, and 52B are used to implement a fine scroll by one step. Thus, two operation methods are used in combination.

In the drag-scroll technique in (B) above, a scroll can be performed only within a range over which the mouse pointer 53 can be dragged, i.e., the display area 50. Therefore, the mouse pointer 53 is dragged many times to scroll across a wide range from end to end.

In the keep-scroll technique in (C) above, to scroll a small amount, the distance between the position PA obtained when the mouse button was pressed and the current position PB is reduced, which causes difficulty in implementing a fine scroll.

It is therefore desirable to overcome the foregoing problems.

According to an embodiment of the present invention, there is provided a display scrolling method for scrolling content displayed on a display screen of a display device according to a user operation. The method includes the steps of, when a pointer of a pointing device is started to be dragged, calculating an amount of scrolling of the content to be scrolled with respect to a unit amount of movement of the pointer on the basis of a distance between the position of the pointer and a predetermined reference point; and displaying the content by scrolling the content displayed on the display screen by the determined amount of scrolling in a direction associated with a moving direction of the pointer.

According to the embodiment of the present invention, the amount of scrolling differs depending on the dragged position, and a fine scroll or quick rough scroll can be implemented by performing the same dragging operation. Therefore, even a large amount of display content can be scrolled through quickly or slowly to easily search for and display a desired portion of the display content. Furthermore, a single dragging operation can be performed to implement a quick or slow scroll, and an easy-to-operate mechanism can be realized.

### BRIEF DESCRIPTION OF THE DRAWINGS

FIG. 1 is a diagram showing an example display according to an embodiment of the present invention;

FIGS. 2A and B are diagrams showing a scrolling method and operation according to the embodiment of the present invention;

FIGS. 3A to 3C are diagrams showing the scrolling method and operation according to the embodiment of the present invention;

FIGS. 4A to 4A are diagrams showing the scrolling method and operation according to the embodiment of the present invention;

FIG. 5 is a diagram showing the operation of a scroll dial according to the embodiment of the present invention;

FIG. 6 is a block diagram showing a display scrolling apparatus according to an embodiment of the present invention;

FIG. 7 is a flowchart showing the operation of the display scrolling apparatus according to the embodiment of the present invention;

FIG. 8 is a block diagram of a display scrolling apparatus according to another embodiment of the present invention;

FIGS. 9A and 9B are diagrams showing a scrolling method and operation according to an embodiment of the present invention;

FIG. 10 is a diagram showing an example display according to an embodiment of the present invention;

FIG. 11 is a diagram showing another example display according to an embodiment of the present invention;

FIG. 12 is a diagram showing a scrolling method and operation according to an embodiment of the present invention;

FIG. 13 is a diagram showing a scrolling method;

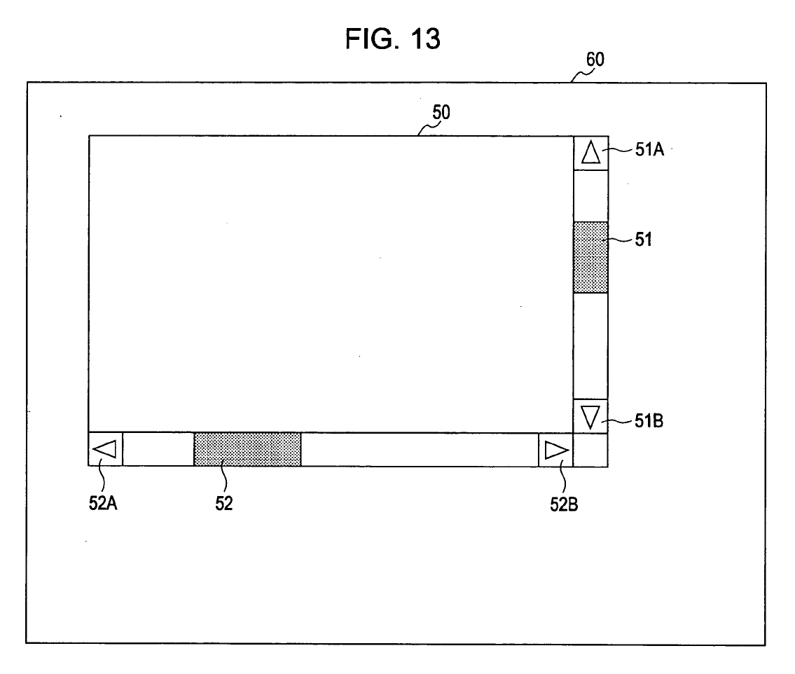

FIG. 14 is a diagram showing another scrolling method; and

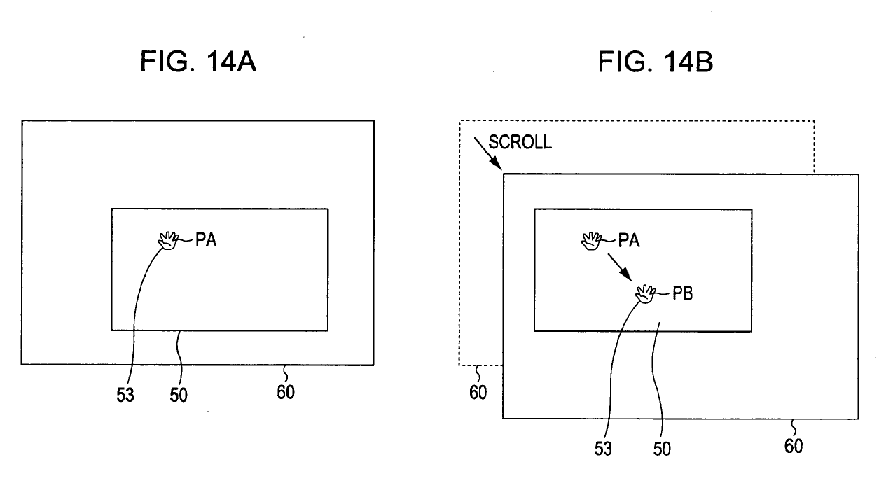

FIG. 15 is a diagram showing still another scrolling method.

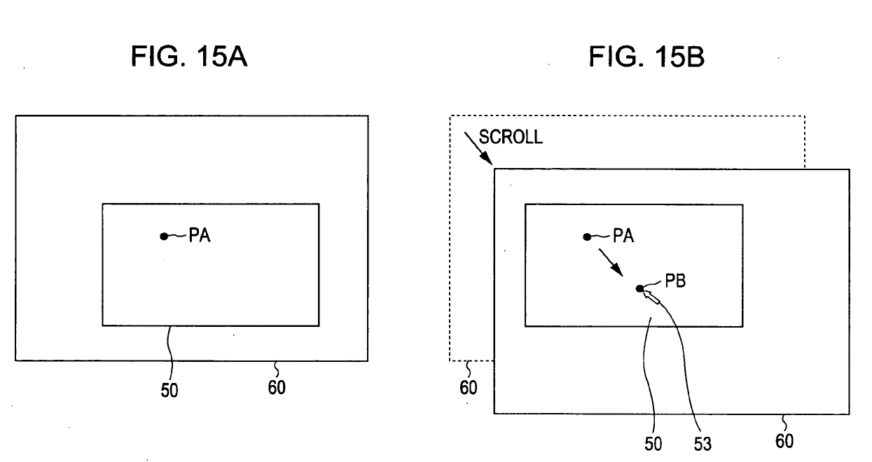

### DESCRIPTION OF THE PREFERRED EMBODIMENTS

### Overview

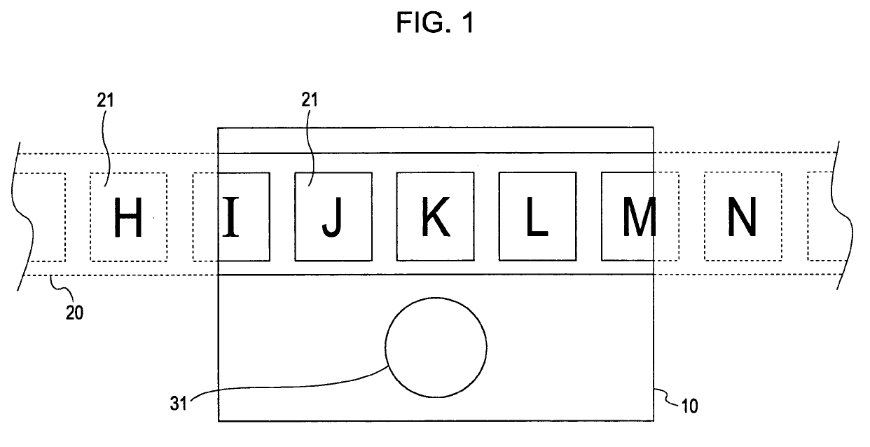

FIG. 1 shows an example display of content according to an embodiment of the present invention, e.g., thumbnails of compact disc (CD) cover images. The thumbnails are arranged in chronological order by date of sale, and a desired thumbnail can be displayed by horizontally scrolling the thumbnails according to a user's operation.

In FIG. 1, a display area (or display window) 10 on a display screen of a display device has a horizontally elongated rectangular shape. The display area 10 may extend over the entire display screen or only a portion thereof.

On the display area 10, for example, in an upper portion thereof, display content 20 is displayed. In FIG. 1, the display content 20 is a collection of a plurality of thumbnails 21 of CD cover images. The thumbnails 21 are arranged from left to right in chronological order by date of sale of the CDs to form the display content 20. Since (or if) the number of thumbnails 21 is large, some of the thumbnails 21 are displayed on the display area 10, and the remaining thumbnails 21 are outside the display area 10 and are not displayed. In FIG. 1, among the thumbnails 21, thumbnails that are not displayed in the display area 10 are indicated by broken lines.

In the following description, the thumbnails 21 are arranged at a pitch of 100 pixels. In FIG. 1, for easy understanding of the state or result of scrolling the thumbnails 21 (the display content 20), images displayed as the thumbnails 21 are represented by alphabets.

A disc-shaped scroll dial 31 is displayed on a lower portion of the display area 10. The scroll dial 31 is rotated in a virtual fashion using a mouse pointer 32. The operation of rotating the scroll dial 31 using the mouse pointer 32 means an operation of placing the mouse pointer 32 on the scroll dial 31 and moving the mouse pointer 32 along the circumference of the scroll dial 31 while pressing a mouse button when the mouse pointer 32 is located on the scroll dial 31. That is, it means an operation of rotationally dragging the scroll dial 31.

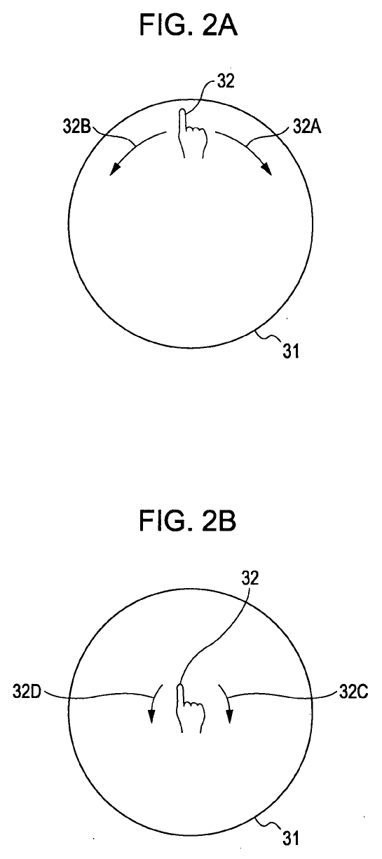

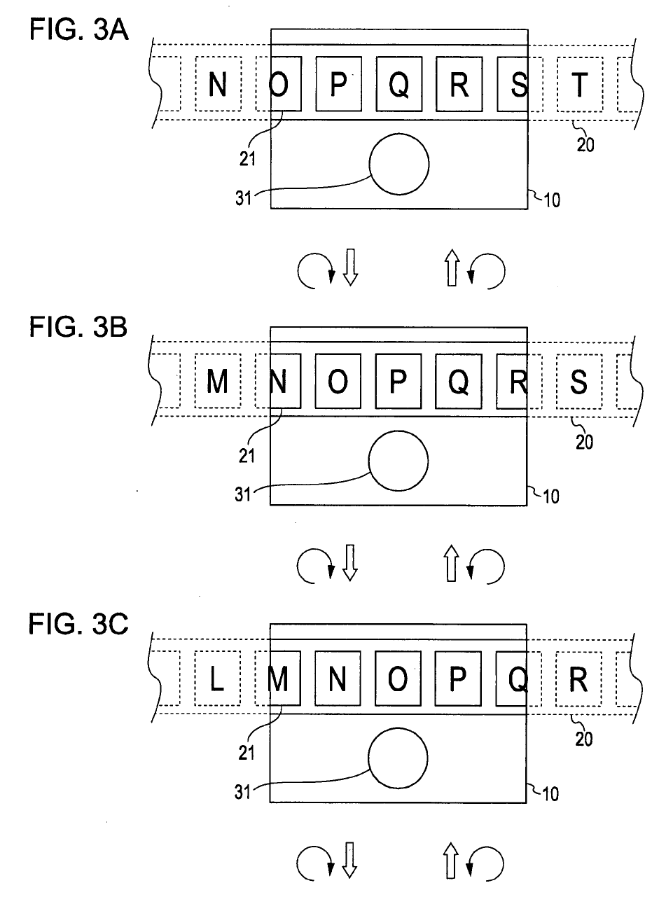

For example, as indicated by an arrow 32A shown in FIG. 2A, when the scroll dial 31 is rotated (i.e., dragged) clockwise using the mouse pointer 32, the display content 20 is scrolled from left to right in a sequential manner as shown in, for example, FIGS. 3A, 3B, and 3C, and one of the thumbnails 21 that is located left outside the display area 10 is moved so as to be displayed in the display area 10, and is then scrolled to the right outside the display area 10.

As indicated by an arrow 32B shown in FIG. 2A, when the scroll dial 31 is rotated counterclockwise using the mouse pointer 32, the display content 20 is scrolled from right to left in a sequential manner as shown in, for example, FIGS. 3C, 3B, and 3A, and one of the thumbnails 21 that is located right outside the display area 10 is moved so as to be displayed in the display area 10, and is then scrolled to the left outside the display area 10.

Therefore, when the scroll dial 31 is rotated in a virtual manner using the mouse pointer 32, the display content 20 (the thumbnails 21) is horizontally moved a predetermined proportion in the direction of rotation of the scroll dial 31, thus implementing a horizontal scroll.

In the embodiment of the present invention, in addition to performing the above-described scrolling, the amount of scrolling is also changed. That is, the amount of scrolling (the scroll speed) of the display content 20 to be horizontally scrolled is changed according to the position within the scroll dial 31 at which the mouse pointer 32 is placed when the scroll dial 31 is rotated (i.e., the radial distance from the center of the scroll dial 31).

FIGS. 3A to 3C show the case where the mouse pointer 32 is placed within and near an outer circumference of the scroll dial 31 and the scroll dial 31 is rotated (i.e., dragged) in the manner indicated by the arrow 32A or 32B shown in FIG. 2A. When the mouse pointer 32 is placed within and near the outer circumference of the scroll dial 31 and the scroll dial 31 is rotated, as shown in FIGS. 3A to 3C, the amount of scrolling of the display content 20 with respect to the unit amount of rotation of the dial 31 is small.

For example, when the mouse pointer 32 is placed within and near the outer circumference of the scroll dial 31 and the scroll dial 31 is rotated by 1°, the display content 20 is moved by one pixel. In FIGS. 3A to 3C, the scroll dial 31 is rotated by 100° to move the display content 20 by 100 pixels on a pixel-by-pixel basis from the state shown in FIG. 3A to the state shown in FIG. 3B, and the scroll dial 31 is further rotated by 100° to move the display content 20 by 100 pixels on a pixel-by-pixel basis from the state shown in FIG. 3B to the state shown in FIG. 3C. Consequently, the thumbnails 21 are scrolled two steps on a pixel-by-pixel basis.

As shown in FIG. 2B, when the mouse pointer 32 is placed around the center of the scroll dial 31 and the scroll dial 31 is rotated in a manner indicated by an arrow 32C or 32D, the display content 20 is also moved in the direction of rotation of the scroll dial 31. When the mouse pointer 32 is placed around the center of the scroll dial 31 and the scroll dial 31 is rotated, however, the amount of scrolling of the display content 20 with respect to the unit amount of rotation of the scroll dial 31 is large.

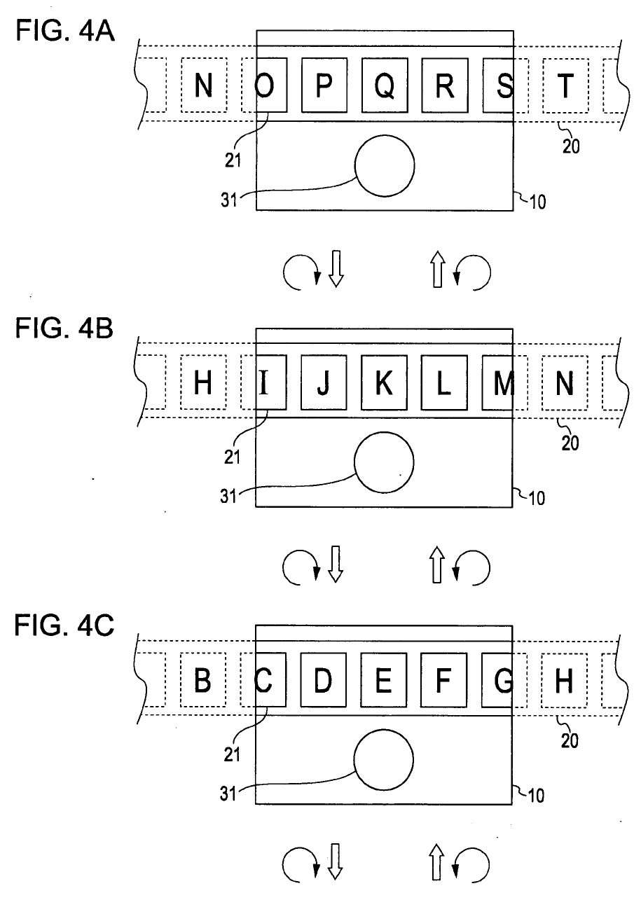

For example, when the mouse pointer 32 is placed around the center of the scroll dial 31 and the scroll dial 31 is rotated by 1°, the display content 20 is moved by 100 pixels. In FIGS. 4A to 4C, the scroll dial 31 is rotated by 6° to move the display content 20 by 600 pixels on a pixel-by-pixel basis from the state shown in FIG. 4A to the state shown in FIG. 4B, and the scroll dial 31 is further rotated by 6° to move the display content 20 by 600 pixels on a pixel-by-pixel basis from the state shown in FIG. 4B to the state shown in FIG. 4C. Consequently, the thumbnails 21 are scrolled 12 steps on a pixel-by-pixel basis.

It is to be understood that when the mouse pointer 32 is placed at an intermediate position between the positions of the scroll dial 31 shown in FIGS. 2A and 2B and the scroll dial 31 is rotated, the amount of scrolling of the thumbnails 21 is an intermediate amount between the that shown in FIGS. 3A to 3C and that shown in FIGS. 4A to 4C.

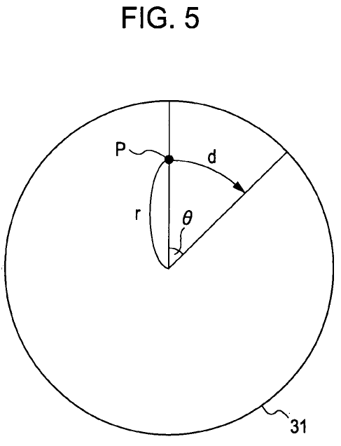

Referring to FIG. 5 in which the mouse pointer 32 is placed at a point P in the scroll dial 31, when the scroll dial 31 is rotated, the following relation is obtained:

θ=d/r Eq. (1)

where d denotes the amount of movement (the distance) of the point P when the scroll dial 31 is rotated, r denotes the distance from the center (i.e., a reference point) of the scroll dial 31 to the point P (where r>0, and the distance r is smaller than the radius of the scroll dial 31), and θ denotes the angle of rotation of the scroll dial 31 (in rad).

If the amount of scrolling of the display content 20 is denoted by L, the amount of scrolling L of the display content 20 is determined by the equation below in accordance with the angle of rotation θ:

L=α·θ

where α denotes a positive constant. Thus, from Eq. (1), the following equation is obtained:

L=α·d/r Eq. (2)

That is, the amount of scrolling (the amount of movement) L of the display content 20 with respect to the unit amount of rotation of the scroll dial 31 is changed in inverse proportion to the distance r between the point P in the scroll dial 31 at which the mouse pointer 32 is placed and the center of the scroll dial 31.

Therefore, when the mouse pointer 32 is placed within and near the outer circumference of the scroll dial 31 and the scroll dial 31 is rotated in the manner shown in FIG. 2A, the distance r is large and thus the amount of scrolling L of the display content 20 determined by Eq. (2) is small. When the mouse pointer 32 is placed around the center of the scroll dial 31 and the scroll dial 31 is rotated in the manner shown in FIG. 2B, the distance r is small and thus the amount of scrolling L of the display content 20 determined by Eq. (2) is large.

The relationship between the distance r from the center point (i.e., the reference point) of the scroll dial 31 to the mouse pointer 32 and the amount of scrolling L of the display content 20 with respect to the amount of rotation θ of the scroll dial 31 may be linear or non-linear, e.g., exponential, or stepwise (or discrete).

Accordingly, the scroll dial 31 is rotated using the mouse pointer 32, thereby horizontally scrolling the display content 20 in the direction of rotation of the scroll dial 31, and changing the amount of scrolling L of the display content 20 according to the position (the point P) at which the mouse pointer 32 is placed to rotate the scroll dial 31.

If one of the thumbnails 21 that is located at a not-so-distant position is displayed, the scroll dial 31 may be rotated by dragging the mouse pointer 32 near and along the outer circumference of the scroll dial 31 in the manner shown in FIG. 2A. Conversely, if one of the thumbnails 21 that is located at a largely distant position is displayed, the scroll dial 31 may be rotated by dragging the mouse pointer 32 around the center of the scroll dial 31 in the manner shown in FIG. 2B.

Therefore, the above-described scrolling method allows an optimum scroll in accordance with the relationship between a current display position and a target display position. Since the scroll dial 31 is rotated, there is no problem if the display content 20 is scrolled out of the display area 10.

Hardware and software for implementing the above-described scrolling will now be described.

### Example Hardware Implementation

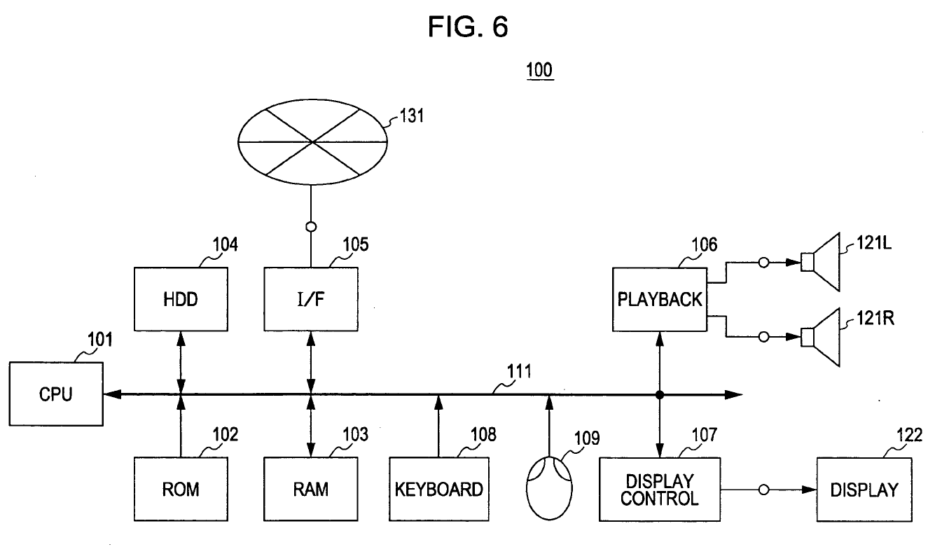

FIG. 6 shows an example structure of a personal computer 100 according to the embodiment of the present invention. The personal computer 100 has a structure similar to that of a general personal computer, and includes a central processing unit (CPU) 101, a read-only memory (ROM) 102, and a random access memory (RAM) 103. The CPU 101 executes various programs, and the ROM 102 stores a basic input/output system (BIOS) or basic data to be executed by the CPU 101. The RAM 102 serves as a work area when the CPU 101 executes a program. The memories 102 and 103 are connected to the CPU 101 via a system bus 111.

A hard disk drive 104 serving as a large-capacity storage device is also connected to the system bus 111. The hard disk drive 104 stores an operating system (OS) for activating the personal computer 100, a program for implementing the display of the thumbnails 21 described above, digital audio data played back as music, and image data for displaying music CD cover images as the thumbnails 21.

A local area network (LAN) interface circuit 105 is also connected to the system bus 111, and the personal computer 100 is connected to an external network 131 via the LAN interface 105. Although not shown, a home server, a network attached storage (NAS) device, an external server, a high-level network, etc., are connected to the network 131.

The personal computer 100 further includes an audio playback circuit 106 and a display control circuit 107, which are also connected to the system bus 111. Upon receiving digital audio data, the audio playback circuit 106 converts the digital audio data into an analog audio signal, and supplies the analog audio signal to speakers 121L and 121R.

The display control circuit 107 includes a video RAM (not shown). Display data is supplied to the video RAM, and is repeatedly read at predetermined intervals and converted into a video signal. The video signal is supplied to a display 122 to display an image. A keyboard 108 serving as a text input unit and a mouse 109 serving as a pointing device are also connected to the system bus 111.

### Example Software Implementation

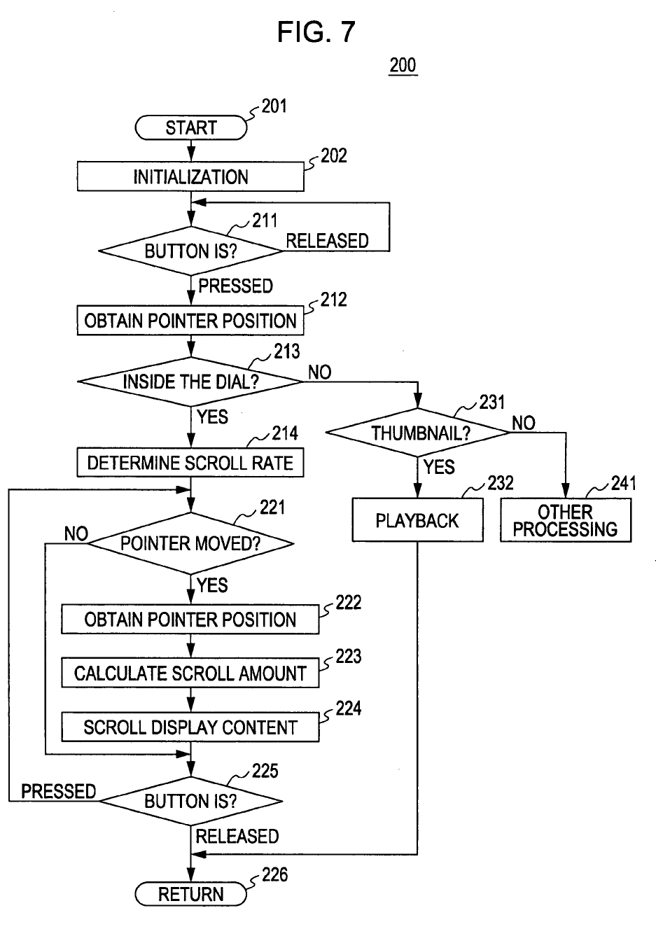

FIG. 7 is a flowchart showing an example routine 200 for implementing the display of the thumbnails 21 described above. The routine 200 is stored in the hard disk drive 104, and is loaded into the RAM 103 by the CPU 101 for execution. In the routine 200 shown in FIG. 7, only portions relating to the embodiment of the present invention are extracted and shown. A user performs a necessary operation using the keyboard 108 or the mouse 109.

When the execution of the routine 200 is instructed, the process executed by the CPU 101 starts with step 201 of the routine 200. In step 202, initialization is performed. In the initialization processing, predetermined image data is read from the hard disk drive 104 and is supplied to the display control circuit 107 to display the display area 10 and the scroll dial 31 on the display 122. In the initialization processing, further, for example, image data corresponding to the thumbnails 21 stored in the hard disk drive 104 is read and is supplied to the display control circuit 107. As a result, for example, as shown in FIG. 1, the thumbnails 21 are displayed in chronological order by date of sale on the display 122.

Then, in step 211, it is determined whether or not a left button of the mouse 109 has been pressed, and the process waits for pressing the left button. When the left button of the mouse 109 is pressed, the process proceeds from step 211 to step 212, and the current coordinates (the point P) of the mouse pointer 32 are obtained. Then, in step 213, it is determined whether or not the position of the mouse pointer 32 obtained in step 212 is located inside the circle of the scroll dial 31.

If the position of the mouse pointer 32 is located inside the scroll dial 31, the user is allowed to rotate the scroll dial 31 in a virtual manner. Thus, in step 214, the distance r from the center (the reference point) of the scroll dial 31 to the mouse pointer 32 is detected, and the amount of scrolling of the display content 20 when the scroll dial 31 is rotated by a unit amount, e.g., 1°, is determined from the distance r. That is, a “scroll rate” is determined.

Then, the process proceeds to step 221. In step 221, it is determined whether or not the mouse pointer 32 has been moved (i.e., dragged). If the mouse pointer 32 has been moved, the process proceeds from step 221 to step 222, and the coordinates of the mouse pointer 32 after movement are obtained. Then, in step 223, the amount of scrolling L of the display content 20 is determined according to Eq. (2) from the scroll rate determined in step 214, the coordinates of the mouse pointer 32 obtained in step 212, and the coordinates of the mouse pointer 32 obtained in step 222. In step 224, the display content 20 is scrolled by the amount of scrolling L determined in step 223.

In step 225, it is determined whether or not the left button of the mouse 109 is kept pressed. If the left button is kept pressed, the process returns from step 225 to step 221. If the left button is not pressed, the process proceeds from step 225 to step 226, and ends the routine 200.

Therefore, as described above, when the scroll dial 31 is rotated using the mouse pointer 32, the display content 20 is horizontally scrolled in the direction of rotation of the scroll dial 31, and the amount of scrolling of the display content 20 is changed according to the position at which the mouse pointer 32 is placed to rotate the scroll dial 31.

In this case, if one of the thumbnails 21 that is located at a not-so-distant position is displayed, the scroll dial 31 may be rotated by dragging the mouse pointer 32 near and along the outer circumference of the scroll dial 31 in the manner shown in FIG. 2A. On the other hand, if one of the thumbnails 21 that is located at a largely distant position is displayed, the scroll dial 31 may be rotated by dragging the mouse pointer 32 around the center of the scroll dial 31 in the manner shown in FIG. 2B. Therefore, the routine 200 allows an optimum scroll in accordance with the relationship between a current display position and a target display position.

If it is determined in step 213 that the position of the mouse pointer 32 obtained in step 212 is not located inside the circle of the scroll dial 31, the process proceeds from step 213 to step 231. In step 231, it is determined whether or not the mouse pointer 32 is located at one of the thumbnails 21 displayed in the display area 10.

If the mouse pointer 32 is located at one of the thumbnails 21 displayed in the display area 10, the process proceeds from step 231 to step 232. In step 232, the digital audio data of the music corresponding to the thumbnail at which the mouse pointer 32 is located is read from the hard disk drive 104, and the read digital audio data is supplied to the playback circuit 106 for digital-to-analog (D/A) conversion into an analog audio signal. The analog audio signal is supplied to the speakers 121L and 121R.

Therefore, once one of the thumbnails 21 displayed in the display area 10 is pointed by the mouse pointer 32, the music displayed as the pointed thumbnail 21 can be played back. When the playback of the music is finished, in the routine 200 shown in FIG. 7, the process of the CPU 101 proceeds from step 232 to step 226, and ends the routine 200.

If it is determined in step 231 that the mouse pointer 32 is not located in any of the thumbnails 21, the process proceeds from step 231 to step 241. In step 241, processing based on the current position of the mouse pointer 32, e.g., termination processing, is performed.

If it is determined in step 221 that the mouse pointer has not been moved, the process proceeds to step 225. In this case, no operation is performed for the user.

### Another Example Hardware Implementation

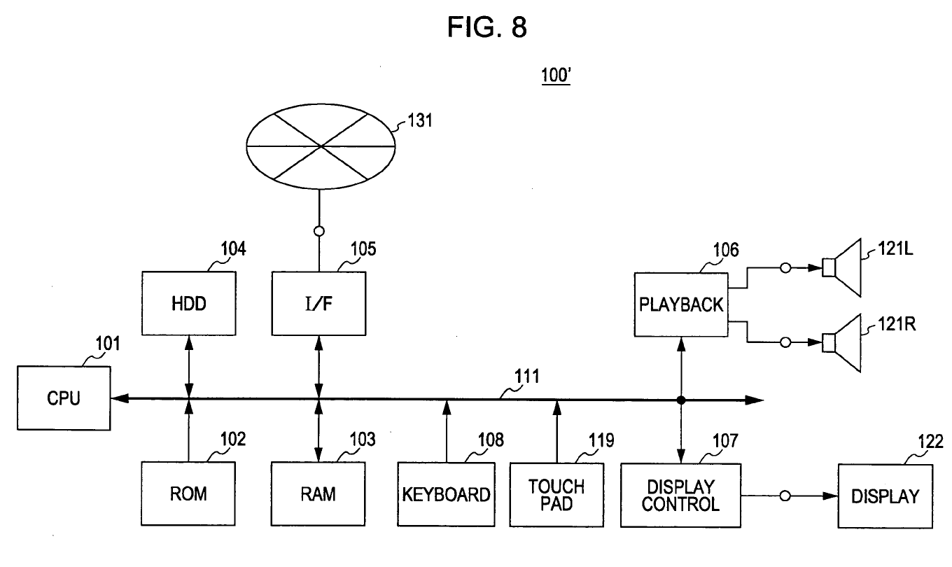

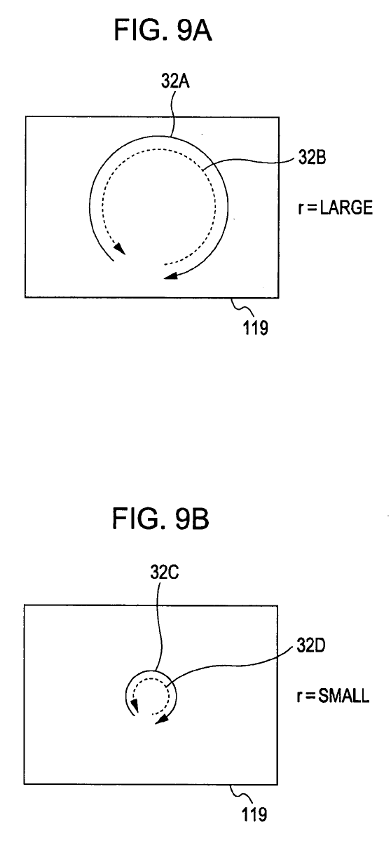

FIG. 8 shows an example structure of a notebook personal computer 100′ according to another embodiment of the present invention. In this example, a touch pad 119 is connected as a pointing device in place of the mouse pointer 109. Like a touch panel or tablet, the touch pad 119 is configured such that an input screen of the touch pad 119 is touched with a finger or stylus to input coordinates. As shown in FIGS. 9A and 9B, for example, the input screen has a horizontally elongated rectangular shape. When the input screen is touched (or lightly pressed) with a stylus, a finger, or the like, the touch is detected and the coordinates of the touched point are read.

In this example, the scroll dial 31 is not displayed but only the display content 20 is displayed on the display area 10.

As shown in FIG. 9A or 9B, when the user draws a circle (or an arc) (or the user touches so as to draw a circle) on the touch pad 119, the display content 20 displayed on the display area 10 is scrolled in a direction associated with the direction in which the circle is drawn, and the radius of the circle drawn on the touch pad 119 is set as the distance r given in Eq. (2).

Therefore, as shown in FIG. 9A, when a large circle is drawn on the touch pad 119, as in the case shown in FIG. 2A in which the mouse pointer 32 is placed within and near the outer circumference of the scroll dial 31 and the scroll dial 31 is rotated, the display content 20 is scrolled in a direction associated with the direction in which the circle is drawn in the manner shown in, for example, FIGS. 3A to 3C. In this case, the amount of scrolling of the display content 20 is small.

As shown in FIG. 9B, when a small circle is drawn on the touch pad 119, as in the case shown in FIG. 2B in which the mouse pointer 32 is placed around the center of the scroll dial 31 and the scroll dial 31 is rotated, the display content 20 is scrolled in a direction associated with the direction in which the circle is drawn in the manner shown in, for example, FIGS. 4A to 4C. In this case, the amount of scrolling of the display content 20 is large.

In an application where the touch pad 119 is used, when a circle is drawn on the touch pad 119, the display content 20 is horizontally scrolled in the direction in which the circle is drawn, and the amount of scrolling of the display content 20 is changed according to the radius r of the drawn circle.

Therefore, even if one of the thumbnails 21 that is located at a not-so-distant position is displayed, or conversely, if one of the thumbnail 21s that is located at a largely distant position is displayed, the desired thumbnail 21 can easily be displayed.

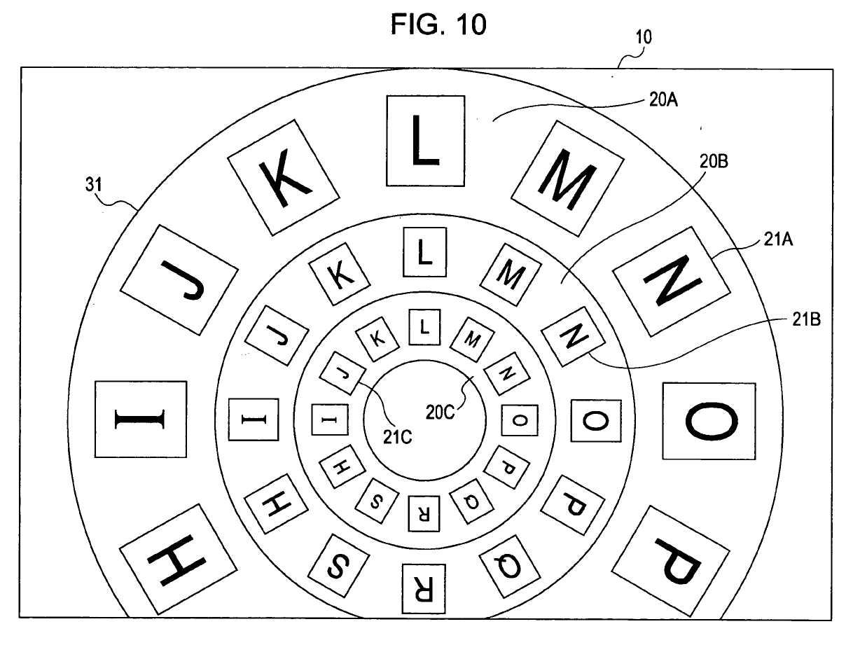

FIG. 10 shows a first example display. In the example shown in FIG. 10, the scroll dial 31 is displayed in a large size, and three display content items, namely, first to third display content items 20A to 20C, are displayed in a triple-layered fashion on the scroll dial 31. The first display content item 20A includes a plurality of thumbnails 21A arranged along an outermost circumference of the scroll dial 31, the center axis of which is aligned with the axis of rotation of the scroll dial 31, and are displayed so that the thumbnails 21A for one turn of the scroll dial 31 are arranged in the scroll dial 31.

Further, the second display content item 20B is displayed on the inner side of the first display content item 20A in a similar manner to that of the first display content item 20A, and the third display content item 20C is displayed on the inner side of the second display content item 20B in a similar manner to that of the first display content item 20A. The thumbnails 21A to 21C of the display content items 20A to 20C that are located on the same radius are regarded as thumbnails having the same content.

As the scroll dial 21 is rotated, the circularly arranged thumbnails 21A to 21C are scrolled in the circumferential direction and sequentially appear.

Also in this case, when the scroll dial 31 is rotated, the more distant from the center the position of the mouse pointer 32 (i.e., the larger the distance r), the smaller the amount of scrolling L. That is, the amount of scrolling of the display content item 20C is larger than that of the display content item 20B, and the amount of scrolling of the display content item 20B is larger than that of the display content item 20A when they are dragged.

Therefore, when the scroll dial 31 is rotated by placing the mouse pointer 32 within and near an outer circumference of the scroll dial 31, a fine scroll can be implemented, whereas when the scroll dial 31 is rotated by placing the mouse pointer 32 around the center of the scroll dial 31, a quick rough scroll can be implemented. Since the thumbnails 21 of the display content 20 are circularly arranged, the display content 20 having an infinite length can be displayed in appearance.

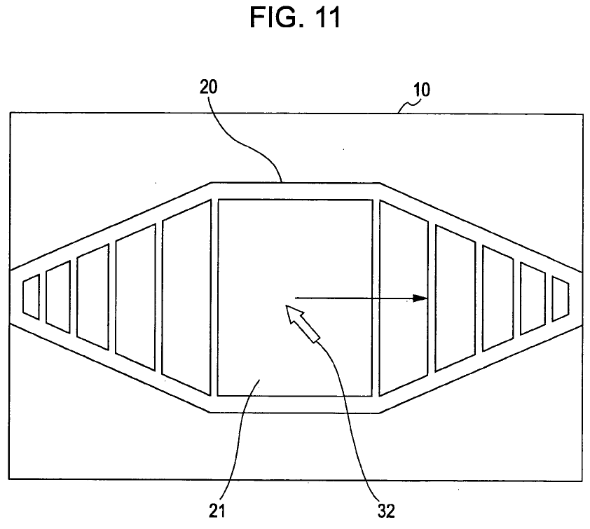

FIG. 11 shows a second example display in which the display content 20 having a horizontally elongated shape is displayed in a three-dimensional manner. That is, a plurality of thumbnails 21 are arranged in a strip in the horizontal direction to form the display content 20, and are displayed so as to move from the rear left to the front and then to the rear right of the display area 10, or conversely, from the rear right to the front and then to the rear left of the display area 10. One of the thumbnails 21 that is located at the center is displayed with unchanged size and shape while the thumbnails 21 that are located on the right and left sides of the center one are displayed with their size reduced as the thumbnails 21 become more distant from the center.

The thumbnails 21 are scrolled to the left or right according to the operation of the mouse 109 or the touch pad 119. The amount of scrolling decreases as the mouse pointer 32 approaches the center of the display area 10. Therefore, when the mouse pointer 32 is dragged around the center of the display content 20, the display content 20 is scrolled a small amount, whereas when the mouse pointer 32 is dragged around the left or right end of the display content 20, the display content 20 is scrolled a large amount.

With this setting, a fine scroll can be provided when the mouse pointer 32 is close to the center of the display content 20, whereas a quick rough scroll can be provided when the mouse pointer 32 is close to both ends of the display content 20. Furthermore, the three-dimensional display of the display content 20 allows the user to intuitively perceive a larger amount of scrolling in the back than in the front.

### Other Embodiments

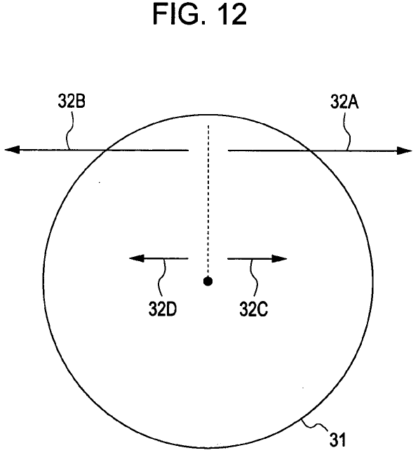

FIGS. 2A and 2B show the case where the mouse 109 is dragged to rotate the scroll dial 31 in the manner indicated by the arrows 32A to 32D. For example, as shown in FIG. 12, the mouse 109 can be dragged to move the scroll dial 31 in the horizontal direction. Also in this case, the amount of scrolling can be changed according to the distance r between a point with which a drag is started on the scroll dial 31 and the center of the scroll dial 31.

In the above-described embodiment, a cross-shaped cursor key and a set key can be used as a pointing device. In this case, the distance r given in Eq. (2) is sequentially changed each time the set key is pressed. Further, when the cross-shaped cursor key is pressed, the display content is scrolled in a direction indicated by the pressed cross-shaped cursor key for a period of time during which the cross-shaped cursor key is pressed. That is, any pointing device that allows for detection of both the position (coordinates) of the start point of the pointer when the display content is dragged and the amount of movement of the display content can be used.

In the foregoing embodiment, the thumbnails 21 of the display content 20 represent CD cover images. The thumbnails 21 of the display content 20 may include thumbnails of other content such as chronologies, front covers of books, various materials, personal photographs, still images, motion pictures, and music downloadable over the network 131. When a desired one of the thumbnails 21 is clicked, the content (main body) associated with the clicked thumbnail 21 can be displayed at its exact size or can be downloaded.

It should be understood by those skilled in the art that various modifications, combinations, sub-combinations and alterations may occur depending on design requirements and other factors insofar as they are within the scope of the appended claims or the equivalents thereof.

What is claimed is:

1. A display scrolling method for scrolling content displayed on a display screen of a display device according to a user operation, the method comprising the steps of:
when a pointer of a pointing device is started to be dragged, calculating an amount of scrolling of the content to be scrolled with respect to a unit amount of movement of the pointer on the basis of a distance between the position of the pointer and a predetermined reference point; and
displaying the content by scrolling the content displayed on the display screen by the determined amount of scrolling in a direction associated with a moving direction of the pointer.

2. The display scrolling method according to claim 1, wherein the reference point comprises a center of a circle displayed on the display screen, and
the moving direction of the pointer comprises a direction of an inner circumference of the circle.

3. The display scrolling method according to claim 2, wherein the amount of scrolling of the content to be scrolled with respect to the unit amount of movement of the pointer decreases as the distance between the position of the pointer and the reference point increases.

4. The display scrolling method according to claim 1, wherein the content is scrolled so that the content can be displayed in a three-dimensional manner.

5. The display scrolling method according to claim 1, wherein the pointing device comprises a touch pad.

6. A display scrolling device for scrolling content displayed on a display screen of a display device according to a user operation, the device comprising:
a pointing device;
calculating means for, when a pointer of the pointing device is started to be dragged, calculating an amount of scrolling of the content to be scrolled with respect to a unit amount of movement of the pointer on the basis of a distance between the position of the pointer and a predetermined reference point; and
displaying means for displaying the content by scrolling the content displayed on the display screen by the determined amount of scrolling in a direction associated with a moving direction of the pointer.

7. The display scrolling device according to claim 6, wherein the reference point comprises a center of a circle displayed on the display screen, and
the moving direction of the pointer comprises a direction of an inner circumference of the circle.

8. The display scrolling device according to claim 6, wherein the pointing device comprises a touch pad.

9. A recording medium having recorded thereon a computer-readable program for scrolling content displayed on a display screen of a display device according to a user operation, the program allowing a computer to execute:
a calculating step of, when a pointer of a pointing device is started to be dragged, calculating an amount of scrolling of the content to be scrolled with respect to a unit amount of movement of the pointer on the basis of a distance between the position of the pointer and a predetermined reference point; and
a displaying step of displaying the content by scrolling the content displayed on the display screen by the determined amount of scrolling in a direction associated with a moving direction of the pointer.

10. A display scrolling device for scrolling content displayed on a display screen of a display device according to a user operation, the device comprising:
a pointing device;
a calculating unit configured to, when a pointer of the pointing device is started to be dragged, calculate an amount of scrolling of the content to be scrolled with respect to a unit amount of movement of the pointer on the basis of a distance between the position of the pointer and a predetermined reference point; and
a displaying unit configured to display the content by scrolling the content displayed on the display screen by the determined amount of scrolling in a direction associated with a moving direction of the pointer.
